(19) United States
(12) Patent Application Publication
(10) Pub. No.: US 2005/0064380 A1
(43) Pub. Date: Mar. 24, 2005

(54) Teaching Tie

(76) Inventor: Donny Patrick Ponder, Olive Branch, MS (US)

Correspondence Address: Donny Ponder, 10162 Tally Ho Dr., Olive Branch, MS, 38654, US

(21) Appl. No.: 10/842,287

(22) Filed: May 10, 2004

Related U.S. Application Data
(60) Provisional application No. 60/469,226, filed on May 12, 2003.

(51) Int. Cl. G09B 25/00

(52) U.S. Cl. 434/365

(57) ABSTRACT

Traditionally, there are three methods by which most people have learned to tie a necktie including printed instructions, watching a video or by having someone physically demonstrate the steps to them. For many people, it is challenging to look at these forms of instruction and then to look down at a tie around their neck and duplicate the steps. The Teaching Tie was designed to make it easy to memorize the steps of tying a necktie by placing the steps as part of the graphical design on the front side of a necktie. Using the Teaching Tie, the wearer can look down at the tie around their neck and see each step that has been strategically placed and oriented to be visible precisely where that step is to be performed in the process of tying a particular type of knot.

### CROSS-REFERENCE TO RELATED APPLICATIONS

This Utility Patent application is in reference to Provisional Patent No. 60/469,226 filed on May 12, 2003. The Title of the Provisional Patent was “Teaching Tie”. It is the intention of this Utility Patent application to convert the existing Provisional Patent to a Utility Patent application. The Provisional Patent Filing Receipt form was mailed to me from USPTO on Jun. 26, 2003. A copy of this form has been included with this application. The Confirmation number on the Provisional Patent Filing Receipt form is 7283.

### BACKGROUND OF INVENTION

Many people have occasions that require them to wear a necktie. For many people, learning to tie a necktie is a challenge. Traditionally, most people learn to tie a necktie from a book/printed paper instructions, video or from someone physically demonstrating the steps to them. Using any of the aforementioned forms of instruction, the wearer faces the challenge of looking at the demonstrated steps and then having to look down with the necktie around their neck and duplicate the steps they have seen. The difficulty is that the wearer has to look at the instructions from a frontal view and then duplicate the steps looking down at the tie around their neck. The view looking down with a necktie around your neck is backwards and upside down compared to a frontal view looking at the aforementioned traditional instructions. For many people, it is difficult to mentally translate the instructions seen from a frontal view and then duplicate them backwards and upside down looking down at the necktie around their neck. The Teaching Tie was designed to overcome this problem. The Teaching Tie contains the steps for tying a necktie within the graphical design of the necktie. With this design, the wearer can learn and memorize the steps for tying a necktie while looking down at the necktie with the necktie around their neck.

### BREIF SUMARRY OF INVENTION

It is an object of this invention to provide a necktie as an instructional tool to teach the wearer how to tie a necktie. In this invention, the steps for tying a necktie are placed as part of the graphical design on the front of the tie (the side facing away from the wearer). Each step is strategically placed in the graphical design on the front of the tie (the side facing away from the wearer) so that the step will appear precisely where it is performed in the process of tying the necktie. Furthermore, each step on the necktie is oriented so that it will appear in such a manor that the wearer can read the step while looking down at the necktie around their neck. Each step placed in the graphical design of the necktie will include a graphical drawing of how the tie should look at that step and what action should be performed next. The user will place The Teaching Tie around their neck and follow the steps on the tie to learn and memorize the steps of tying a necktie.

The steps and instructions for tying a necktie can be painted, printed, embroidered, woven or attached by chemical, thermal, physical (such as stitching, Velcro etc.) bonding to the surface of the necktie. As there are many different types of knots that can be used to tie a necktie, different Teaching Ties can be manufactured with a different graphical design for each knot. As will be stated in the Claims section of this documentation, the patent being sought will not be unique to one particular knot or another.

### BRIEF DESCRIPTION OF THE DRAWINGS

The following drawings with multiple views are provided to give a better understanding of this invention.

FIG. 1 is a view of the front (the side facing away from the wearer) of a necktie. This drawing includes an example of steps for tying a necktie placed in the graphical design on the front (the side facing away from the wearer) of a necktie.

FIG. 2(A) (B) (C) (D) (E) show views of a necktie as seen from the perspective of the wearer with the tie around their neck. These drawings show how each step should be placed in precise locations and orientations within the graphical design on the front (the side facing away from the wearer) of the tie so that they will appear and can be read exactly where the specific step is performed. The step designs and the number of steps shown in this drawing are given as an example, as there are many different variants of step design, placement and the number of steps required for the many different methods of typing a necktie.

### DESCRIPTION OF PREFERRED EMBODIMENT

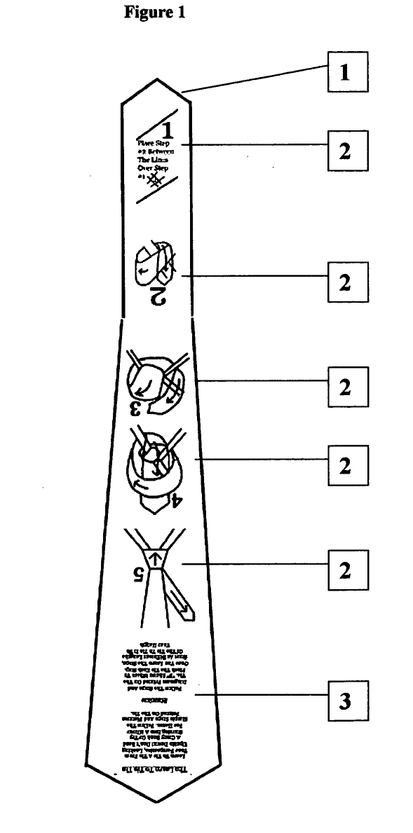

Referring to the drawings, FIG. 1 shows a conventional necktie (1) front, outward side (the side facing away from the wearer). This necktie can be of any shape or size and any material. Further, in FIG. 1, it is shown how steps (2) and instructions (3) for tying a necktie can be placed in the graphical design on the front side (The side facing away from the wearer) of the necktie. Placing steps and instructions in the graphical design on the front side (the side facing away from the wearer) of a necktie makes the tie useful as an instructional tool to teach the wearer to tie a necktie. The steps placed in the graphical design on the necktie may include any necessary combination of illustrations, text and/or numbers. To my knowledge, a necktie that teaches the wearer to tie a necktie through its graphical design does not exist in the market. To attest to the Teaching Tie's uniqueness, a tie with any other type of graphical design cannot teach a person to tie a necktie. However, because the Teaching Tie includes steps and instructions placed in strategic locations in the graphical design of the tie, the wearer is able to learn the steps of tying a necktie from the tie.

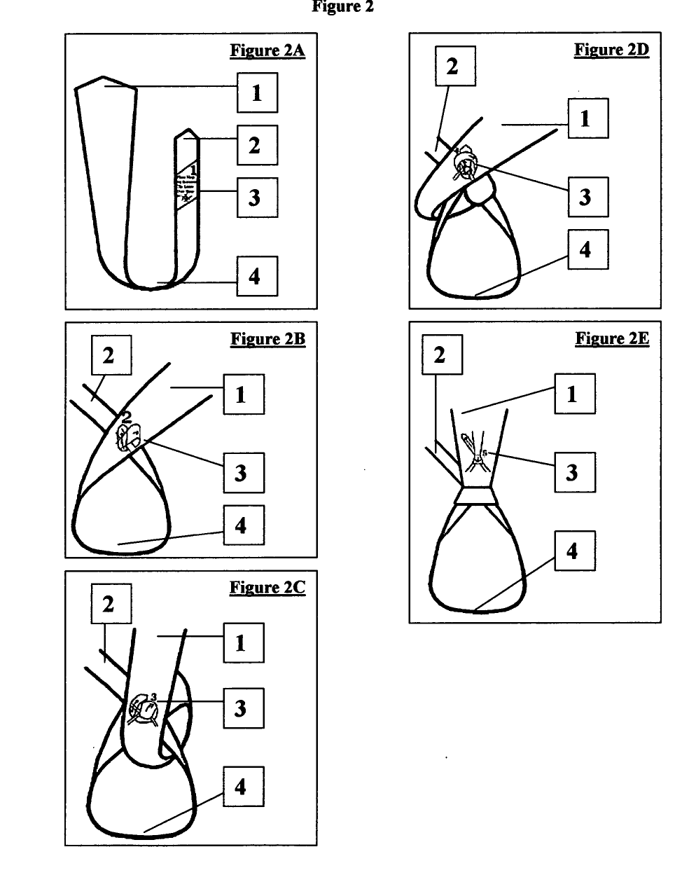

In FIGS. 2(A) (B) (C) (D) and (E), the drawings are from the perspective of the wearer looking down at the tie around their neck. (1) shows the wide end of the front side (the side facing away from the wearer) of a necktie. Also in FIGS. 2(A) (B) (C) (D) and (E), (2) shows the narrow end of the front side (the side facing way from the wearer) of a necktie. Additionally in FIGS. 2(A) (B) (C) (D) and (E), (3) shows how each step placed in the design of the tie must be placed in a precise location and orientation so that it appears to the wearer and can be read by the wearer exactly where that step is to be performed. In FIGS. 2(A) (B) (C) (D) and (E), (4) shows how the tie is around the wearer's neck while they are viewing the steps on the tie. The steps and instructions for tying a necktie can be placed on the tie by printing, painting, weaving, embroidering, or by chemical, thermal or physical (stitching, Velcro etc.) bonding on the front (the side facing away from the wearer) of a necktie. The information in the steps and instructions can be made of any material such as ink, thread, paint, metal, plastic, and textile.

The broader use of this invention may be illustrated by the following examples.

### EXAMPLES OF APPLICATION

### Example #1

Half Windsor Knot

The Half Windsor Knot was used as an example in the drawings. The Half Windsor Knot is tied in five steps. Each of the five steps must be placed in the graphical design of the necktie so they will display exactly where each specific step respectively is performed.

### Example #2

Full Windsor Knot

The Full Windsor Knot requires extra steps in comparison to a Half Windsor Knot. A Teaching Tie manufactured to teach the Full Windsor Knot would include more steps. Again, these steps would be placed in precise locations and orientations so that they will appear exactly where they are performed.

### Example #3

Four Hand Knot

The Four Hand Knot is a different type of knot from a Full or Half Windsor Knot. A Teaching Tie manufactured to teach the Four Hand Knot would include the unique steps for tying this type of knot. Each step would be placed on the tie so it would appear precisely where that step is to be performed.

1. A necktie comprising of a wide end and a narrow end; said wide end and said narrow end having a front side that will face away from the wearer; said front side having a graphic design that includes steps and/or instructions for any method of tying a necktie that are permanently placed on said front side.

2. The necktie of claim 1; wherein said steps and/or instructions for tying a necktie contain any combination of text, illustrations, numbers or color.

3. The necktie of claim 1 and claim 2; wherein said steps and/or instructions for any method of tying a necktie are placed on said front side by a placing means selected from the group consisting of printing, screen printing, painting, weaving, embroidering, or by chemical, thermal or physical (stitching, Velcro etc.) bonding.
